(19) United States
(12) Patent Application Publication
(10) Pub. No.: US 2023/0393973 A1
(43) Pub. Date: Dec. 7, 2023

(54) APPARATUS AND METHOD FOR OBTAINING DATA ASSOCIATED WITH A PROCESSING CIRCUITRY, APPARATUS AND METHOD FOR SENDING A REQUEST FOR DATA ERASURE

(71) Applicant: Intel Corporation, Santa Clara, CA (US)

(72) Inventors: Rajesh POORNACHANDRAN, PORTLAND, OR (US); Vincent ZIMMER, Issaquah, WA (US)

(21) Appl. No.: 18/193,683

(22) Filed: Mar. 31, 2023

(51) Int. Cl. G06F 12/02; G06F 11/30

(52) U.S. Cl. CPC G06F 12/0246; G06F 11/3037; G06F 2212/7205

(57) ABSTRACT

It is proposed an apparatus, the apparatus comprising interface circuitry, machine-readable instructions, and a semiconductor die comprising processing circuitry to execute the machine-readable instructions to obtain data associated with the processing circuitry, and store the data in non-volatile memory integrated into the semiconductor die.

### BACKGROUND

Reselling of used hardware components such as processors may be of ecological as well as of economic value. However, there may be several hurdles to the resale of such components including a lack of trusted measures to prove the quality of the hardware components and a significant risk of data leakage, as sensitive information may be inadvertently or intentionally stored on these hardware components and may potentially be accessed by unauthorized parties. Hence, there may be a demand for improved quality monitoring and data security.

### BRIEF DESCRIPTION OF THE FIGURES

Some examples of apparatuses and/or methods will be described in the following by way of example only, and with reference to the accompanying figures, in which

FIGS. 1a and 1b illustrate an example of an apparatus for obtaining data associated with a processing circuitry;

FIGS. 2a and 2b illustrate an example of an apparatus for sending a request for data erasure;

FIG. 3 illustrates an example of a system;

FIG. 4 illustrates an example of a method;

FIG. 5 illustrates an example of a configuration flow; and

FIG. 6 illustrates another example of a configuration flow.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

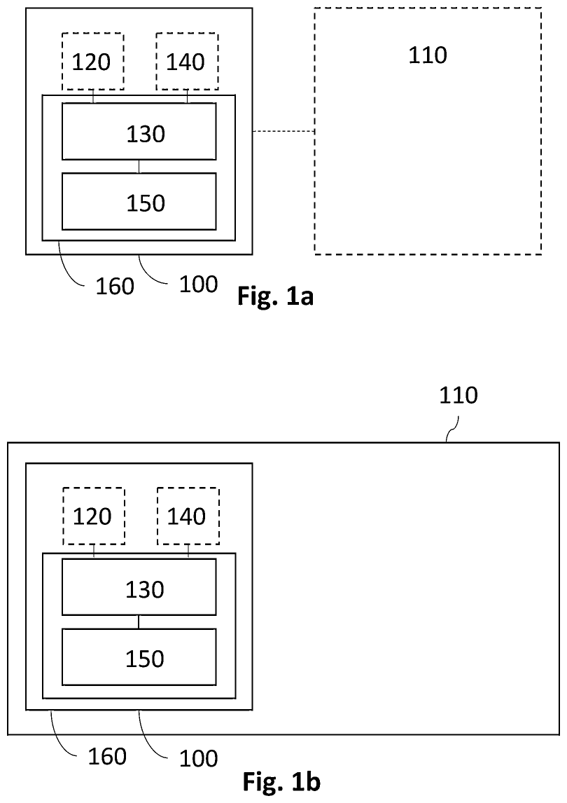

FIG. 1a shows a block diagram of an example of an apparatus 100 or device 100 communicatively coupled to a computer system 110. FIG. 1b shows a block diagram of an example of a computer system 110 comprising an apparatus 100 or device 100.

The apparatus 100 comprises circuitry that is configured to provide the functionality of the apparatus 100. For example, the apparatus 100 of FIGS. 1a and 1b comprises (optional) interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120 (for exchanging information, e.g., with other components inside or outside the computer system 110) and/or the storage circuitry 140 (e.g., for storing information, such as machine-readable instructions).

Likewise, the device 100 may comprise means that is/are configured to provide the functionality of the device 100. The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, (optional) means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry or means for storing may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

The processing circuitry 130 may be any computing resource, e.g., a central processing unit (CPU). For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components of the processing circuitry 130. Such hardware components may comprise a general-purpose processor, a Digital Signal Processor (DSP), a micro-controller, a microprocessor, a graphics processing unit, a field-programmable gate array, a network interface controller, etc.

The apparatus 100 further comprises non-volatile memory 150. Non-volatile memory 150 may refer to a type of computer memory may retain stored data even when the power supply to the apparatus 100 is turned off. The non-volatile memory 150 may include flash memory, EEPROM (Electrically Erasable Programmable Read-Only Memory) or non-volatile random-access memory (RAM) such as ferroelectric RAM, magneto-resistive RAM and resistive RAM, or phase-change memory (PCM).

The processing circuitry 130 and the non-volatile memory 150 are integrated/embedded into a (single) semiconductor die 160, e.g., into the same semiconductor die 160. The semiconductor die 160 may be an electronic chip of semiconductor material (e.g., silicon) on which electronic components are integrated for realizing the processing circuitry 130 and the non-volatile memory 150. The semiconductor die 160 may be a single unit that performs the various functions of the processing circuitry 130 and the non-volatile memory 150.

The non-volatile memory 150 may thus be implemented as on-die memory, i.e., memory that is integrated onto the same semiconductor die 160 as the processing circuitry 130, e.g., a processor. This means that the memory 150 may be physically located on the same chip as the processing circuitry 130, rather than being a separate component. For instance, the non-volatile memory 150 may be internal storage, e.g., an internal register, of a the processing circuitry 130.

The processing circuitry 130 is configured to obtain data associated with the processing circuitry 130. For example, the processing circuitry 130 may determine at least partially the data itself and/or at least partially receive the data, e.g., via the interface circuitry 120. The data may be any data which allow conclusion about a type of the processing circuitry 130 and its history, i.e., usage, provenance, etc. For instance, the data (e.g., usage/provenance data) may indicate at least one of a previous usage, a previous usage at elevated temperature, an age, a life expectancy, a provenance, a deployment model, a recorded failure and a recorded malfunction, etc., of the processing circuitry 130.

The processing circuitry 130 may in some example be configured to determine the data by monitoring a usage of the processing circuitry 130. Usage monitoring may involve tracking performance metrics/indicators related to the operation of the processing circuitry 130, such as utilization, clock speed, temperature, power consumption, and other. For instance, the processing circuitry 130 may implement performance monitoring counters (PMCs), e.g., hardware-based performance counters, which may be built into the processing circuitry 130. These counters may track the usage of the processing circuitry 130, such as the number of instructions executed, the number of cache misses, and alike. Additionally or alternatively, the processing circuitry 130 may use a software-based monitoring method such as sampling or tracing. Sampling may involve periodically taking snapshots of the state of the processing circuitry 130 state and analyzing these snapshots to determine how the processing circuitry 130 is being used. Tracing may involve recording the execution of specific instructions or events in the processing circuitry 130, e.g., to trace the flow of control and identify performance bottlenecks. Additionally or alternatively, the processing circuitry 130 may track abnormal or malicious behavior of the processing circuitry 130, e.g., by monitoring for unauthorized access or activity or for signs of malware or other security threats.

The processing circuitry 130 is further configured to store the data in the non-volatile memory 150 integrated into the semiconductor die 160.

The apparatus 100 may, in this manner, take advantage of secure on-die storage with secure metering of CPU usage in terms of age and actual usage telemetry. Thus, the apparatus 100 may provide a (e.g., CPU) ‘usage odometer’ which can be used to prove the ‘mileage’ of the hardware, such as how much it is used, how often used at elevated temperature or the projected future life of the apparatus 100—the latter may be realized based on sensor fusion in a back-end cloud connected to the apparatus 100, e.g., via an artificial model based on broad silicon deployment datasets. The apparatus 100 may further enable a proof that the processing circuitry 130 is a genuine device, not a grey market item.

The apparatus 100 may generally enhance the data integrity of the usage/provenance data since the on-die storing of the data may provide for improved performance and reliability as well as enhanced security features such as encryption and secure boot. The apparatus 100 may be particularly beneficial for applications where the security of the data and system uptime are critical, such as in mission-critical systems, data centers, and other enterprise applications.

The apparatus 100 may enable secure vintage provenance tracking of computing ingredients for efficient reuse in a circular economy. Ownership transfer may be a key emergent capability in the circular economy. Today's platforms may lack a capability to perform secure provenance tracking including the age, deployment model of the system ingredients, especially most expensive parts including CPUs and memory modules. As a result, in a circular reuse economy, consumers may miss a way to gauge the quality, longevity of a recycled computing resource (e.g., CPU hardware). By contrast, the apparatus 100 may ensure that the designated future owner of the apparatus 100 may have confidence in the provenance, health, and potential future utility of the device.

Conventionally, decommissioned computing resources are scrapped and newly produced processors have to be purchased. Instead, the apparatus 100 may aim at providing the precondition for refurbishing or waterfalling. The manufacturer however may still benefit from this technique by, e.g., licensing and registering of processors for building trust in the quality indications, administering of the usage/provenance data or second-life trading such that the manufacturer may have incremental revenue across re-used/re-cycled machines through the supply chain.

An owner of a computing system may scrap the hardware due to data leakage concern instead of selling/waterfalling to next owner to use older hardware. Only some buyers and sellers of a minority market segment may recycle the hardware with the tradeoff of data confidentiality/privacy. Likewise, a second owner of the computing system may be concerned if there is any malicious residue from previous users or any privacy leak. This problem may additionally be addressed by the apparatus 100 featuring a ‘smart sanitizer.’

For example, the processing circuitry 130 may be configured to tag the data as not to be erased from the non-volatile memory 150. This may enable a data erasure of the non-volatile memory 150 omitting the usage/provenance data. Thus, sensitive or private data can be erased, e.g., for owner transfer of the apparatus 100, without losing the valuable information (the data) about the usage which may help a future owner to assess the quality or likewise help the present owner to prove the quality of the apparatus 100. The tagging may further enhance the efficiency of the data erasure and the manageability of the non-volatile memory 150 whereas conventional data erasure may be time-consuming and unregulated. For instance, zero-izing non-volatile RAM may entail many iterations. The apparatus 100 may address this problem by providing intelligent microcode/XuCode flows which may perform a multi-erase, e.g., in a fault-tolerant and transactional fashion.

The processing circuitry 130 may use any tagging technique. For example, the processing circuitry 130 may add the tag (an indication that the data is not to be erased) to metadata, a label or an annotation of the data. The processing circuitry 130 may use a structuring technique to organize the data into a specific format or schema indicating that the data is not to be erased. The processing circuitry 130 may use a markup language to tag the data with specific syntax or code to indicate that it is not to be erased. Alternatively, the tag may be stored in an address register of the non-volatile memory 150 which may increase the speed of accessing the tagged data or filtering the tagged/untagged data.

When data erasure is required, the processing circuitry 130 may act on it in the following way: The processing circuitry 130 may be configured, in response to a request for data erasure, erase further data from the non-volatile memory. The further data is different from the data (tagged as not to be erased). The further data may be, e.g., comprise confidential data which is not to be disclosed to the next owner of the apparatus 100. For instance, the processing circuitry 130 may be configured to erase the further data by overwriting or degaussing a memory region of the further data.

Conventionally, there may be no self-sanitize capability. Thus, primary or first users of a CPU hardware may be concerned with data confidentiality which hinders the reuse or sell of the hardware. This type of capability may be of particular interest for cloud service providers that often retire 30-70% of their fleet per year and would benefit from a re-sell. Such an aftermarket would extend the longevity of semiconductors. Given the conventional model of hardware roots of trust that bind the original firmware to the platform via fuses, without the technique provided by the apparatus 100 there is no tenable scheme for ownership transfer.

For further improvements in the efficiency of the data erasure, the apparatus 100 may additionally enable a selective erasure of the confidential further data whereas the (usage) data and non-confidential data may stay on the non-volatile memory 150. For example, the processing circuitry 130 may be configured to tag the further data as to be erased from the non-volatile memory 150. In response to a request for data erasure, the processing circuitry 130 may be configured to exclusively erase the tagged further data from the non-volatile memory. This may increase the speed and overall performance of the data erasure (self-sanitization). A further measure for performance increase may be the processing circuitry 130 being configured to store the tagged further data in a contiguous memory region of the non-volatile memory 150. The latter may simplify the access of the tagged further data for erasure.

In some examples, the processing circuitry 130 is configured to receive a (first) policy indicating whether the data erasure is to be performed in at least one of an interleaved and a simultaneous manner and erase the further data based on the policy. Such a policy may be enforced via a service-level agreement, e.g., negotiated by the apparatus 100 (or the computing system 110) with a device of a user (or owner) of the apparatus 100. The user may determine or select requirements of the data erasure in form of the policy. This policy may allow to predetermine how the data erase shall work, e.g., bulk, or parallel memory banks, interleaved, etc. An interleaved data erasure may be performed on a set of data blocks or sectors across the apparatus 100 and another computing resource (e.g., external hardware or hardware integrated into the computing system 110) simultaneously, rather than erasing data on one device at a time. A simultaneous data erasure may involve erasing data on such multiple computing resources at the same time using a single erasure command. Both data erasure techniques may provide for an effective and secure erasure. In conjunction with a user-specific policy (data destruction policy), the apparatus 100 may ensure that sensitive information is properly protected.

The processing circuitry 130 may, in some examples, further be configured to store an indication of a progress of the data erasure in the non-volatile memory 150. In this manner, the data erasure may be performed in a fault-tolerant way since it may make progress on the scrub across power cycle, resets or restarts of the apparatus 100. For instance, the processing circuitry 130 may track and log the progress of data erasure, e.g., using software or hardware logs. The processing circuitry 130 may also provide an erasure certificate, i.e., a record of the erasure process, e.g., including the date and time of erasure, the method used, and other relevant details. This certificate may be generated based on a digital signature or encryption to reliably provide proof of erasure to third parties, such as the user.

The security provided by the apparatus 100 may further be enhanced by the use of a trusted execution environment (TEE). For instance, the processing circuitry 130 may be configured to determine the data and store the data within a TEE implemented in the semiconductor die 160. The TEE may be a combination of hardware and software components, including, e.g., a secure hardware component such as a secure enclave or a secure processor to provide a secure and isolated environment, a trusted boot process by verifying integrity of the firmware, bootloader, and operating system using cryptographic signatures, isolation from the main operating system, such as that of the computing system 110, by using hardware-based mechanisms such as memory protection or access control, secure communication between the TEE and other parts of the apparatus 100 or the computing system 110 based on encryption and authentication, application programming interfaces that allow trusted applications to interact with the TEE. secure storage (such as the non-volatile memory 150) to store sensitive data such as the encryption keys used for secure communication or biometric data used for authentication. The TEE may prevent unauthorized access to the TEE and protect against attacks such as side-channel attacks or physical tampering.

The access to the non-volatile memory 150, e.g., when the usage/provenance data is to be disclosed to a potential buyer of the apparatus 100, may, for instance, be based on a non-volatile memory express (NVMe) protocol. For instance, the processing circuitry 130 may be configured to send and/or receive the data based on the NVMe protocol. The apparatus 100 may thereby take advantage of secure on-die NVMe or WCE (write cache enabled) based storage with secure metering of CPU usage with additional self-sanitization capability. The NVMe protocol may ensure a low latency of data exchange, e.g., via a PCI (peripheral component interconnect) express interface.

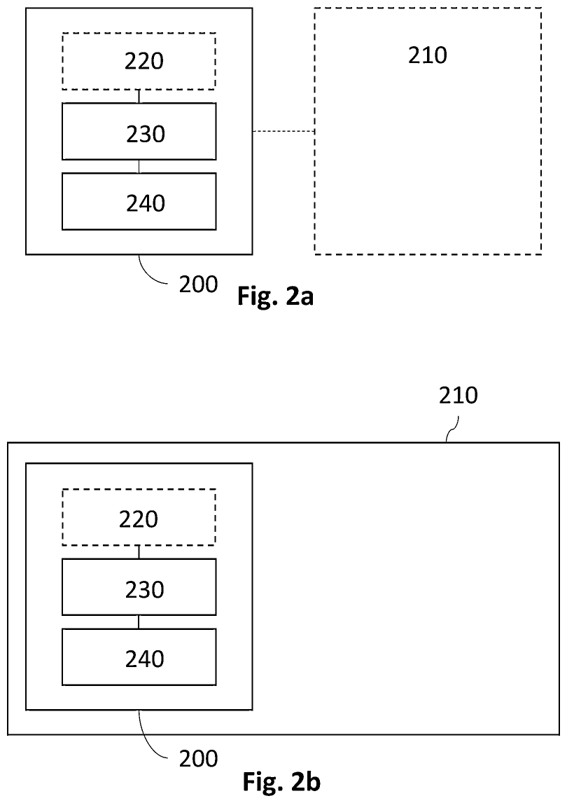

A communication with a platform (a computing system) forming an ecosystem for second use of hardware components may also be established. Such a platform may be an apparatus as explained with reference to FIGS. 2a and 2b below. On such a platform, users may negotiate with the present owner of hardware components (such as the apparatus 100) or a mediator about the terms of sale, rent or other usage of the hardware components. The negotiations may be implemented as automatic process, such as based on a smart contract.

The negotiations may highly benefit from the usage/provenance data of the processing circuitry 130 since the quality or value of the processing circuitry 130 depends on it. The processing circuitry 130 may, for instance, receive a (second) policy for exposing the data and, in response to a request for exposing the data, expose the data based on the received policy. Such policy may be negotiated on a service level and determine the terms and conditions of exposing the data. For instance, the processing circuitry 130 may expose only a part of the data (e.g., based on selective disclosure), an encrypted version of the data, etc. The processing circuitry 130 may also prove a statement about the usage/provenance of the processing circuitry 130 without exposing the data itself, e.g., based on a zero-knowledge proof.

The processing circuitry 150 may in some examples be configured to expose the data by storing the data (or data derived thereof) on a distributed ledger, a centralized storage or a combination thereof. The distributed ledger or centralized storage may be accessible by the external platform or a device held by a potential buyer of the apparatus 100. This may prevent data corruption and build trust on the data integrity of the usage/provenance data.

The communication to the external platform or the user device may require an additional security layer. For instance, the processing circuitry 130 may be configured to receive a credential for authenticating a device making the request to expose the data and expose the data based on the received credential, e.g., only expose the data when the credential is verified. The authentication may, for instance, be based on a public key of the truthful external platform or device, e.g., issued by a trusted authority or stored on a distributed ledger. The processing circuitry 130 may hence establish a secure communication channel to the requesting entity by challenging the entity with the decryption of data encrypted based on the public key and verifying whether the entity sufficiently well masters the challenges.

The apparatus 100 may further comprise microcode memory integrated into the semiconductor die 160. The microcode memory may be configured to store the machine-readable instructions. That is, the technique described herein may be implemented in microcode, i.e., as a layer of software between hardware of the apparatus 100 or the computing system 110 and high-level instructions executed by the processing circuitry 130. The microcode memory may store low-level instructions or firmware that provide a way for the processing circuitry 130 to interpret and execute the more complex high-level instructions from the software that runs on the apparatus 100 or the computing system 110. The microcode may therefore be a way to emulate or translate these high-level instructions into low-level instructions executable by the processing circuitry 130. This microcode implementation may provide a fine-tuning and optimization of the performance of the processing circuitry 130 when executing the machine-readable instructions, such as the usage monitoring or the data storing or erasure, by providing a layer of abstraction between the hardware and the software of the apparatus 100 or the computing system 110. The machine-readable instructions may further be adapted to specific requirements of the processing circuitry 130 or to prevent and fix security vulnerabilities or bugs without a physical modification of the processing circuitry 130. This measure may thus also increase the security of generation, tagging, storage, exposure or erasure of the data or the further data.

The technique presented herein, such as by way of the apparatus 100, may propose a secure vintage provenance tracking of computing architecture ingredients, e.g., using distributed ledger systems. It may leverage distributed ledger for provenance tracking, quality issues & secure audit trail for go-green claims by vendors. A remote out-of-band license provisioning by a manufacture may be provided towards manageability, repair, support in a certified manner for improved reuse, e.g., for certification and extended life & usage across multiple owners in a circular economy. The technique may allow secure sanitization, provenance tracking and audit trail of the hardware ingredients involving both manufacture proprietary and third party hardware. The apparatus 100 may reduce the hardware component manufacturer's carbon footprint. The manufacturer may further experience augmented revenue opportunity in service branches like Trust-as-a-Service for ownership of hardware.

FIG. 2a shows a block diagram of an example of an apparatus 200 or device 200 communicatively coupled to a computer system 210. FIG. 2b shows a block diagram of an example of a computer system 210 comprising an apparatus 200 or device 200.

The apparatus 200 comprises circuitry that is configured to provide the functionality of the apparatus 200. For example, the apparatus 200 of FIGS. 2a and 2b comprises (optional) interface circuitry 220, processing circuitry 230 and storage circuitry 240. For example, the processing circuitry 230 may be coupled with the interface circuitry 220 and with the storage circuitry 240.

For example, the processing circuitry 230 may be configured to provide the functionality of the apparatus 200, in conjunction with the interface circuitry 220 (for exchanging information, e.g., with other components inside or outside the computer system 210) and/or the storage circuitry 240 (e.g., for storing information, such as machine-readable instructions).

Likewise, the device 200 may comprise means that is/are configured to provide the functionality of the device 200. The components of the device 200 are defined as component means, which may correspond to, or implemented by, the respective structural components of the apparatus 200. For example, the device 200 of FIGS. 2a and 2b comprises means for processing 230, which may correspond to or be implemented by the processing circuitry 230, (optional) means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The apparatus 200 may be understood as a counterpart to the apparatus 100 described above. For instance, the apparatus 200 may provide an interface to the apparatus 100 for triggering a data erasure or for requesting data exposure of the apparatus 100. The apparatus 200 may therefore provide a platform for a hardware reuse ecosystem as described above.

The processing circuitry 230 is configured to send a request for data erasure to an external apparatus for obtaining data of a processing circuitry as described herein, such as apparatus 100. The apparatus 200 may, for instance, establish a (secure) communication channel to the external apparatus, e.g., via a computing network. The processing circuitry 230 may send the request for data erasure in response to a request for ownership transfer. For instance, the apparatus 200 may provide a second interface to a potential buyer of the external apparatus which may request the ownership transfer.

For the ability to assess a quality of the external apparatus, the potential buyer may further request usage or provenance data of the external apparatus or retrieve such data from a distributed ledger managed by the apparatus 200. The processing circuitry 130 may therefore be in some examples configured to send a policy for exposing data associated with a processing circuitry of the external apparatus store the exposed data based on the policy. For instance, the processing circuitry 130 may store the exposed data on a distributed ledger.

The apparatus 200 may provide an effective way to prove quality of a processor to a future owner/user of the processor and secure data erasure to the present owner/user. The apparatus 200 may thus enable a reuse ecosystem for a circular economy for hardware components potentially executing applications with access to confidential data.

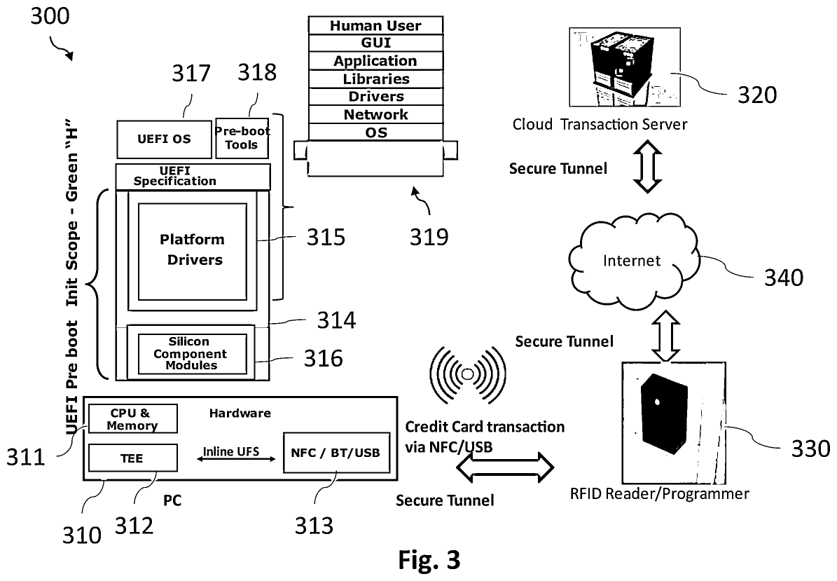

FIG. 3 illustrates an example of an architecture of a system 300 comprising an apparatus 310 for obtaining data of a processing circuitry, such as apparatus 100, and an apparatus 320 for sending a request for data erasure, such as apparatus 200.

The apparatus 310 comprises a processing circuitry (CPU) and non-volatile memory integrated, both into a semiconductor die 311. The apparatus 310 further comprises a TEE implemented in the hardware of the apparatus 310 and an interface 313 (e.g., an NFC (near field communication), BT (Bluetooth) or USB (universal serial bus) interface).

The apparatus 310 further has a software layer 314, including platform drivers 315, silicon component modules 316, as well as a pre-boot environment including UEFI operating system 317 and pre-boot tools 318. Further, the apparatus 310 may have several layers 319 of hardware and firmware, for instance.

The apparatus 310 is configured to obtain data associated with the processing circuitry and store the data in the non-volatile memory integrated into the semiconductor die 311. Machine-readable instructions providing for the execution of said obtaining data and storing data may be implemented into the firmware and/or may be embedded into microcode of the CPU or may be embedded into the TEE.

The apparatus 310 may establish a secure tunnel (communication channel) between the interface 313 and an RFID (radio frequency identification) reader 330. This reader 330 is communicatively coupled to the apparatus 320 via the internet 340.

The apparatus 320 may use this secure tunnel to send a request for data erasure, e.g., in response to a request for ownership transfer, to the apparatus 310. The apparatus 310 may then perform the data erasure as requested but keep the usage/provenance data unchanged. The apparatus 320 may further use the secure tunnel to send a policy for exposing data associated with a processing circuitry of the apparatus 310 and store the exposed data based on the policy, e.g., on a distributed ledger. The apparatus 310 may expose the data based on that policy, e.g., in an encrypted and modified version.

The system 300 may be a concrete implementation example of the solution presented herein that includes a firmware stack 319 on the node 310 for which ownership migration may occur, hardware elements 313 on the node include the RFID and secure storage 311, 312, and a cloud-based transaction server 320 coupled to the node 310 via the internet 340.

The system 300 may provide a secure vintage provenance tracking of computing architecture ingredients, e.g., using distributed ledger systems. It may leverage distributed ledger for provenance tracking, quality issues & secure audit trail for go-green claims by vendors. A remote out-of-band license provisioning by a manufacture may be provided towards manageability, repair, support in a certified manner for improved reuse, e.g., for certification and extended life & usage across multiple owners in a circular economy. The system 300 may allow secure sanitization, provenance tracking and audit trail of the hardware ingredients involving both manufacture proprietary and third party hardware. The system 300 may reduce the hardware component manufacturer's carbon footprint. The manufacturer may further experience augmented revenue opportunity in service branches like Trust-as-a-Service for ownership of hardware.

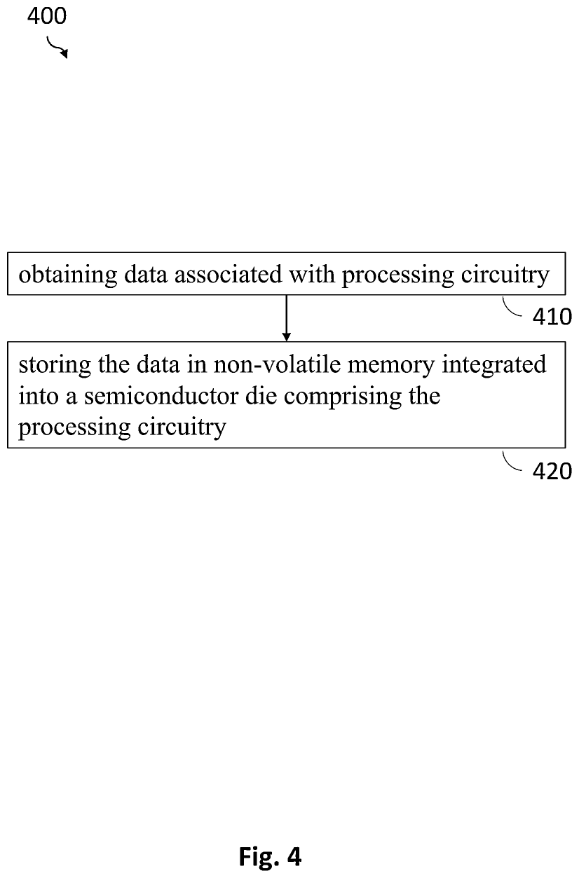

FIG. 4 illustrates an example of a method 400. The method 400 may be executed by an apparatus as described herein, such as apparatus 100. The method 400 comprises obtaining 410 data associated with processing circuitry and storing 420 the data in non-volatile memory integrated into a semiconductor die comprising the processing circuitry.

More details and aspects of the method 400 are explained in connection with the proposed technique or one or more examples described above (e.g., FIGS. 1 to 3). The method 400 may comprise one or more additional optional features corresponding to one or more aspects of the proposed technique, or one or more examples described above.

The method 400 may provide a secure vintage provenance tracking of computing architecture ingredients, e.g., using distributed ledger systems. It may leverage distributed ledger for provenance tracking, quality issues & secure audit trail for go-green claims by vendors. A remote out-of-band license provisioning by a manufacture may be provided towards manageability, repair, support in a certified manner for improved reuse, e.g., for certification and extended life & usage across multiple owners in a circular economy. The method 400 may allow secure sanitization, provenance tracking and audit trail of the hardware ingredients involving both manufacture proprietary and third party hardware. The method 400 may reduce the hardware component manufacturer's carbon footprint. The manufacturer may further experience augmented revenue opportunity in service branches like Trust-as-a-Service for ownership of hardware.

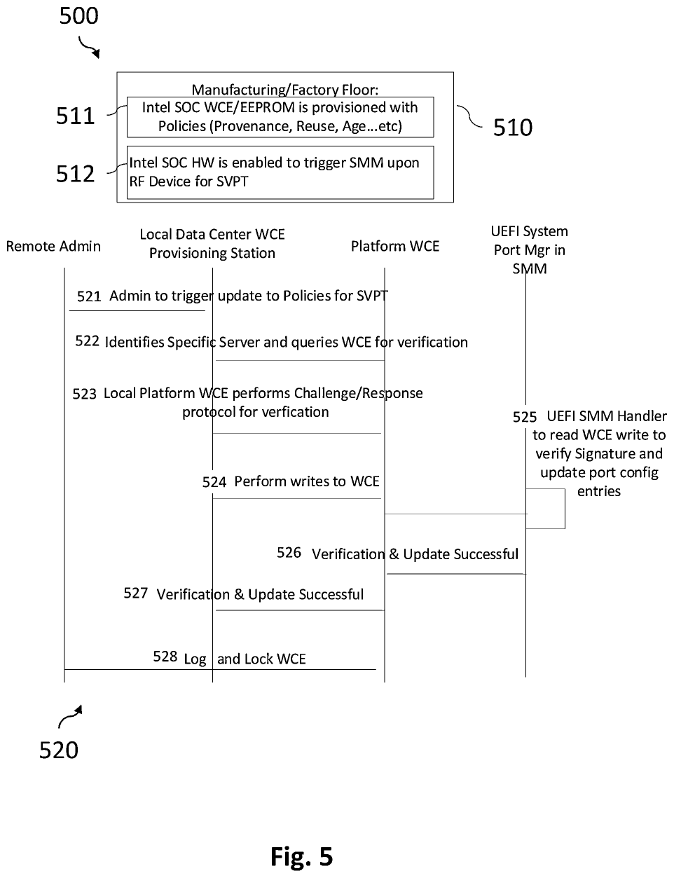

FIG. 5 illustrates an example of a method 500 of a configuration of apparatuses described herein. The method 500 includes a manufacturing/factory floor configuration 510 and a configuration 520 during operation for ownership transfer.

The manufacturing/factory floor configuration 510 comprises provisioning 511 of policies for provenance, reuse, age, etc. within an SoC (System on Chip) EEPROM (electrically erasable programmable read-only memory) of an apparatus, such as apparatus 100. The configuration 510 further comprises enabling 512 a hardware of the apparatus to trigger SMM (system management mode) upon an RF device trigger.

The configuration 520 is illustrated by a signal chart in FIG. 5. The configuration 530 comprises triggering 521 an update on a local data center provisioning center to policies for secure vintage provenance tracking by a remote admin, identifying 522, at the local data center, specific server and querying wireless credential exchange for verification from a platform, and performing 523 challenge/response between the local data center and the platform for verification.

The configuration 530 further comprises performing 524, at the local data center, writes to the platform memory, reading 525, at an UEFI system manager of the platform in system management mode, the writes to verify signature and updating port configuration entries, and indicating 526 at the platform that verification and update is successful.

The configuration 530 comprises indicating 527 to the local data center that verification and update is successful and logging 528 and locking the usage of the platform hardware based on the policies provided at manufacturing level.

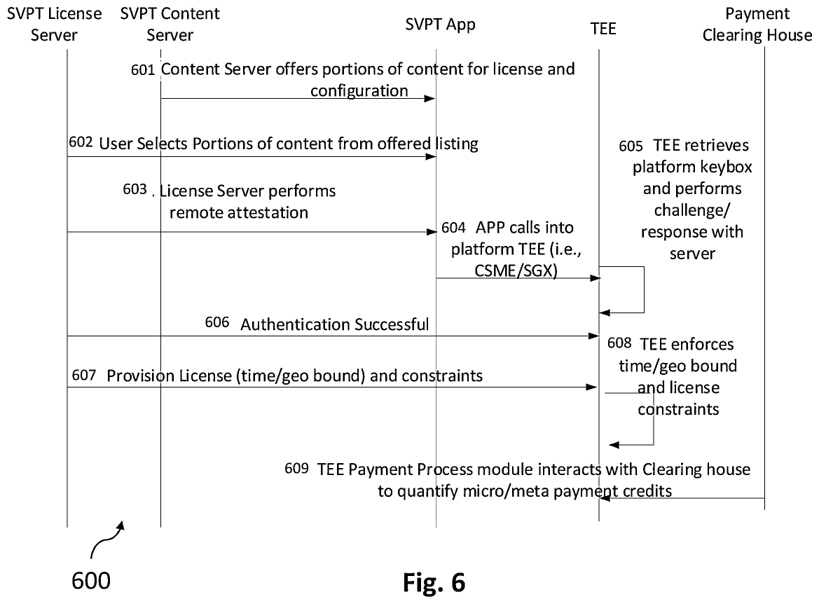

FIG. 6 illustrates a signal chart of an example of another method 600 of a configuration of apparatuses as described herein, such as apparatus 100.

The method 600 comprises offering 601 portions of content for license and configuration between a content server and an application of the apparatus selecting 602, by a user via a license server, portions of content from offered listing at the application, and performing 603 remote attestation of the application by the license server.

The method 600 further comprises calling 604 from the application into the platform TEE, retrieving 605, at the TEE, a platform keybox and performing challenge/response with the server, and indicating 606, by the license server, that the authentication is successful.

The method 600 further comprises providing 607, at the license server, license (time and/or geo bounded) and constraints to the TEE, enforcing 608 at the TEE the time/geo bound and the license constraints, and interacting 609 from the TEE payment process module with a clearing house to quantify micro/meta payment credit.

The methods 500 and 600 may illustrate how a reuse ecosystem could be potentially implemented by the manufacturer of an apparatus as described herein and how the manufacturer may contribute to the reuse ecosystem, e.g., as licensor.

In the following, some examples of the proposed concept are presented:

An example (e.g., example 1) relates to an apparatus, the apparatus comprising interface circuitry, machine-readable instructions, and a semiconductor die comprising processing circuitry to execute the machine-readable instructions to obtain data associated with the processing circuitry, and store the data in non-volatile memory integrated into the semiconductor die.

Another example (e.g., example 2) relates to a previous example (e.g., example 1) or to any other example, further comprising that the data indicates at least one of a previous usage, a previous usage at elevated temperature, an age, a life expectancy, a provenance, a deployment model, a recorded failure and a recorded malfunction of the processing circuitry.

Another example (e.g., example 3) relates to a previous example (e.g., one of the examples 1 or 2) or to any other example, further comprising that the machine-readable instructions further comprise machine-readable instructions to determine the data by monitoring a usage of the processing circuitry.

Another example (e.g., example 4) relates to a previous example (e.g., one of the examples 1 to 3) or to any other example, further comprising that the machine-readable instructions further comprise machine-readable instructions to tag the data as not to be erased from the non-volatile memory.

Another example (e.g., example 5) relates to a previous example (e.g., one of the examples 1 to 4) or to any other example, further comprising that the machine-readable instructions further comprise machine-readable instructions to, in response to a request for data erasure, erase further data from the non-volatile memory, wherein the further data is different from the data tagged as not to be erased.

Another example (e.g., example 6) relates to a previous example (e.g., example 5) or to any other example, further comprising that the machine-readable instructions further comprise machine-readable instructions to erase the further data by overwriting a memory region of the further data.

Another example (e.g., example 7) relates to a previous example (e.g., one of the examples 5 or 6) or to any other example, further comprising that the machine-readable instructions further comprise machine-readable instructions to tag the further data as to be erased from the non-volatile memory, and in response to a request for data erasure, exclusively erase the tagged further data from the non-volatile memory.

Another example (e.g., example 8) relates to a previous example (e.g., example 7) or to any other example, further comprising that the machine-readable instructions further comprise machine-readable instructions to store the tagged further data in a contiguous memory region of the non-volatile memory.

Another example (e.g., example 9) relates to a previous example (e.g., one of the examples 5 to 8) or to any other example, further comprising that the machine-readable instructions further comprise machine-readable instruction to receive a policy indicating whether the data erasure is to be performed in at least one of an interleaved and a simultaneous manner, and erase the further data based on the policy.

Another example (e.g., example 10) relates to a previous example (e.g., one of the examples 5 to 9) or to any other example, further comprising that the machine-readable instructions further comprise machine-readable instructions to store an indication of a progress of the data erasure in the non-volatile memory.

Another example (e.g., example 11) relates to a previous example (e.g., one of the examples 1 to 10) or to any other example, further comprising that the machine-readable instructions further comprise machine-readable instructions to determine the data and store the data within a trusted execution environment implemented in the semiconductor die.

Another example (e.g., example 12) relates to a previous example (e.g., one of the examples 1 to 11) or to any other example, further comprising that the machine-readable instructions further comprise machine-readable instructions to send or receive the data based on a non-volatile memory express, NVMe, protocol.

Another example (e.g., example 13) relates to a previous example (e.g., one of the examples 1 to 12) or to any other example, further comprising that the machine-readable instructions further comprise machine-readable instructions to receive a policy for exposing the data, and in response to a request for exposing the data, expose the data based on the received policy.

Another example (e.g., example 14) relates to a previous example (e.g., example 13) or to any other example, further comprising that the machine-readable instructions further comprise machine-readable instructions to expose the data by storing the data on a distributed ledger.

Another example (e.g., example 15) relates to a previous example (e.g., one of the examples 13 or 14) or to any other example, further comprising that the machine-readable instructions further comprise machine-readable instructions to receive a credential for authenticating a device making the request to expose the data, and expose the data based on the received credential.

Another example (e.g., example 16) relates to a previous example (e.g., one of the examples 1 to 15) or to any other example, further comprising microcode memory integrated into the semiconductor die, wherein the microcode memory is to store the machine-readable instructions.

Another example (e.g., example 17) relates to an apparatus, the apparatus comprising interface circuitry, machine-readable instructions, and processing circuitry to execute the machine-readable instructions to send a request for data erasure to an apparatus according to a previous example (e.g., one of examples 1 to 16) or to any other example.

Another example (e.g., example 18) relates to a previous example (e.g., example 17) or to any other example, further comprising that the machine-readable instructions further comprise machine-readable instructions to send the request for data erasure in response to a request for ownership transfer.

Another example (e.g., example 19) relates to a previous example (e.g., one of the examples 17 or 18) or to any other example, further comprising that the machine-readable instructions further comprise machine-readable instructions to send a policy for exposing data associated with a processing circuitry of the apparatus according to a previous example (e.g., one of examples 1 to 16) or to any other example, and store the exposed data based on the policy.

Another example (e.g., example 20) relates to a previous example (e.g., example 19) or to any other example, further comprising that the machine-readable instructions further comprise machine-readable instructions to store the exposed data on a distributed ledger.

An example (e.g., example 21) relates to a method, comprising obtaining data associated with processing circuitry, and storing the data in non-volatile memory integrated into a semiconductor die comprising the processing circuitry.

Another example (e.g., example 22) relates to a non-transitory machine-readable storage medium including program code, when executed, to cause a machine to perform the method of example 21.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus, the apparatus comprising interface circuitry, machine-readable instructions, and a semiconductor die comprising processing circuitry to execute the machine-readable instructions to:
obtain data associated with the processing circuitry; and
store the data in non-volatile memory integrated into the semiconductor die.

2. The apparatus of claim 1, wherein the data indicates at least one of a previous usage, a previous usage at elevated temperature, an age, a life expectancy, a provenance, a deployment model, a recorded failure and a recorded malfunction of the processing circuitry.

3. The apparatus of claim 1, wherein the machine-readable instructions further comprise machine-readable instructions to determine the data by monitoring a usage of the processing circuitry.

4. The apparatus of claim 1, wherein the machine-readable instructions further comprise machine-readable instructions to tag the data as not to be erased from the non-volatile memory.

5. The apparatus of claim 1, wherein the machine-readable instructions further comprise machine-readable instructions to, in response to a request for data erasure, erase further data from the non-volatile memory, wherein the further data is different from the data tagged as not to be erased.

6. The apparatus of claim 5, wherein the machine-readable instructions further comprise machine-readable instructions to:
tag the further data as to be erased from the non-volatile memory; and
in response to a request for data erasure, exclusively erase the tagged further data from the non-volatile memory.

7. The apparatus of claim 6, wherein the machine-readable instructions further comprise machine-readable instructions to store the tagged further data in a contiguous memory region of the non-volatile memory.

8. The apparatus of claim 5, wherein the machine-readable instructions further comprise machine-readable instruction to:
receive a policy indicating whether the data erasure is to be performed in at least one of an interleaved and a simultaneous manner; and
erase the further data based on the policy.

9. The apparatus of claim 5, wherein the machine-readable instructions further comprise machine-readable instructions to store an indication of a progress of the data erasure in the non-volatile memory.

10. The apparatus of claim 1, wherein the machine-readable instructions further comprise machine-readable instructions to determine the data and store the data within a trusted execution environment implemented in the semiconductor die.

11. The apparatus of claim 1, wherein the machine-readable instructions further comprise machine-readable instructions to send or receive the data based on a non-volatile memory express, NVMe, protocol.

12. The apparatus of claim 1, wherein the machine-readable instructions further comprise machine-readable instructions to:
receive a policy for exposing the data; and
in response to a request for exposing the data, expose the data based on the received policy.

13. The apparatus of claim 12, wherein the machine-readable instructions further comprise machine-readable instructions to expose the data by storing the data on a distributed ledger.

14. The apparatus of claim 1, further comprising microcode memory integrated into the semiconductor die, wherein the microcode memory is to store the machine-readable instructions.

15. An apparatus, the apparatus comprising interface circuitry, machine-readable instructions, and processing circuitry to execute the machine-readable instructions to send a request for data erasure to an apparatus according to claim 1.

16. The apparatus of claim 15, wherein the machine-readable instructions further comprise machine-readable instructions to send the request for data erasure in response to a request for ownership transfer.

17. The apparatus of claim 15, wherein the machine-readable instructions further comprise machine-readable instructions to:
send a policy for exposing data associated with a processing circuitry of the apparatus according to claim 1; and
store the exposed data based on the policy.

18. The apparatus of claim 17, wherein the machine-readable instructions further comprise machine-readable instructions to store the exposed data on a distributed ledger.

19. A method, comprising:
obtaining data associated with processing circuitry; and
storing the data in non-volatile memory integrated into a semiconductor die comprising the processing circuitry.

20. A non-transitory machine-readable storage medium including program code, when executed, to cause a machine to perform the method of claim 19.
